(19) United States
(12) Patent Application Publication
(10) Pub. No.: US 2020/0034765 A1
(43) Pub. Date: Jan. 30, 2020

(54) SYSTEMS AND METHODS FOR CONTEXTUAL ACTIONS USING A MAP INTERFACE

(71) Applicant: ServiceNow, Inc., Santa Clara, CA (US)

(72) Inventors: Sanjay Kumar Gupta, Saratoga, CA (US); Devinder Narang, Palo Alto, CA (US); Venkitesh Subramanian, Fremont, CA (US); Jiwei Xia, Santa Clara, CA (US); Rui Li, Fremont, CA (US)

(21) Appl. No.: 16/047,753

(22) Filed: Jul. 27, 2018

(51) Int. Cl. G06Q 10/06; G06F 17/30; G06F 3/0481; G06F 3/0486

(52) U.S. Cl. CPC G06Q 10/06311; G06Q 10/06316; G06F 3/0486; G06F 3/04817; G06F 17/30241

(57) ABSTRACT

Embodiments of the present disclosure are directed to providing, via a client instance hosted by an enterprise management data-center, an interactive map configured to provide contextual actions on a user interface. Using interaction points of the interactive map, a user may assign tasks, communicate with other users, and search for various elements.

### BACKGROUND

The present disclosure relates generally to an interactive map interface.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In the realm of cloud computing, a user may utilize one or more computing resources to assign service tasks to technicians in the field who are also in communication with the cloud resources. However, as in other contexts where tasks are assigned, such approaches may result in inefficient allocations of resources. For example, the service tasks may be assigned in an unproductive manner that may result in excessive travel times for the technicians.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A user interface may be utilized to assign one or more tasks to a respective agent (e.g., a field service engineer) using one or more lists populated by data indicative of tasks and agents. However, such user interfaces may be limiting in that the geographic context of the tasks and agents may be unknown or poorly utilized. For example, a task may be assigned to a first agent that may located far from a location of the task while there may be a second agent located in a more suitable location to complete the task. Indeed, without geographic context of task locations relative to agent locations, tasks may be inefficiently assigned and/or completed.

Accordingly, present embodiments are directed toward a system for providing an interactive map interface to configure a schedule/complete service tasks based on contextual actions relative to graphic representation of a geographic area. For example, an interactive map may be populated by a plurality of task icons and a plurality of agent icons according to respective geolocations. Tasks may be assigned to the agents by dragging and dropping icons associated with respective agents on the map to icons associated with respective tasks. In this manner, tasks may be contextually assigned based at least in part on geographic location of tasks relative to geographic locations of agents, thereby efficiently assigning tasks. Moreover, the interactive map may be used to search for various items within the geographic location. For example, an agent or overseeing entity may search for parts required to complete assigned tasks and the interactive map may be populated by icons associated with geographic locations of the parts.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud computing system in which embodiments of the present disclosure may operate;

FIG. 2 is a block diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is a block diagram of a computing system that may be present in FIGS. 1, 2, and/or 3, in accordance with aspects of the present disclosure;

FIG. 6 is a block diagram of a computing system that may be present in FIGS. 1, 2, and/or 3 and configured to provide contextual actions via an interactive map, in accordance with aspects of the present disclosure;

FIG. 7 is an embodiment of the interactive map, in accordance with aspects of the present disclosure;

FIG. 8 is a further embodiment of the interactive map, in accordance with aspects of the present disclosure; and

FIG. 9 is a flow chart of to provide contextual actions via an interactive map, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to a single electronic computing device that includes, but is not limited to a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code. As used herein, the term “interactive map” may refer to a visual representation of a geographic area displayed via a display, such as a graphical user interface (GUI). The interactive map may be configured to receive various inputs by manipulation (e.g., drag and drop) of various elements of the interactive map to perform functions relative to the geographic area.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Embodiments of the present disclosure are directed to providing an interactive map interface via a client instance. The actions provided by the map interface may be configurable based on client actions or preferences. For example, a client administrator may determine permissions (e.g., abilities, actions, options) that a particular user may have when accessing the map interface. Depending on the determined permissions, the map interface may provide a user with a variety of abilities. Such abilities may include, for example, assigning tasks (e.g., service, installation, maintenance, appointment), determining a route to a task, determining components (e.g., parts) required for a task and locations of the components, determining locations of certain buildings (e.g., warehouses, bathrooms, headquarters), interaction with other users and so forth.

The map interface may receive input from the user based on dragging and dropping a first icon associated with a geolocation of a first item (e.g., part, task, agent) to a second icon associated with a geolocation of a second item (e.g., part, task, agent). As described herein, based on the client preferences, dragging and dropping the first icon to the second icon may trigger certain actions to take place, such as task assignment. Moreover, the map interface may be searchable. That is, a user may enter a search string in a search field, for example, to determine the location of parts, tasks, agents, and so forth.

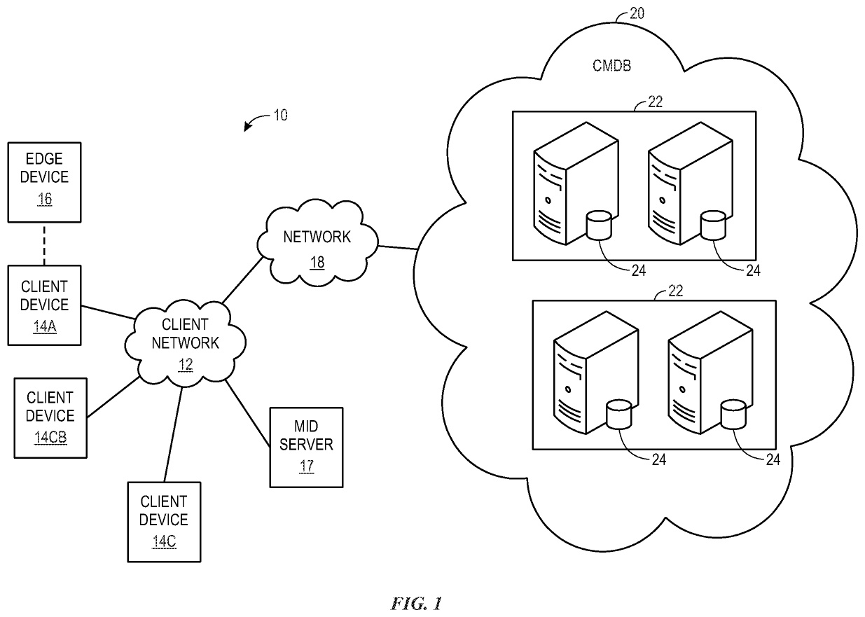

With the preceding in mind, the following figures relate to various types of generalized system architectures or configurations that may be employed to provide services to an organization in a multi-instance framework on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, where embodiments of the present disclosure may operate, is illustrated. Computing system 10 may include a client network 12, network 18 (e.g., the Internet), and a cloud-based platform 20. In some implementations, the cloud-based platform 20 may be a configuration management database (CMDB) platform. In one embodiment, the client network 12 may be a local private network, such as local area network (LAN) that includes a variety of network devices that include, but are not limited to, switches, servers, and routers. In another embodiment, the client network 12 represents an enterprise network that could include one or more LANs, virtual networks, data centers 22, and/or other remote networks. As shown in FIG. 1, the client network 12 is able to connect to one or more client devices 14A, 14B, and 14C so that the client devices are able to communicate with each other and/or with the network hosting the platform 20. The client devices 14A-C may be computing systems and/or other types of computing devices generally referred to as Internet of Things (IoT) devices that access cloud computing services, for example, via a web browser application or via an edge device 16 that may act as a gateway between the client devices and the platform 20. FIG. 1 also illustrates that the client network 12 includes an administrative or managerial server (e.g., a management, instrumentation, and discovery (MID) server 17) that facilitates communication of data between the network hosting the platform 20, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 18. The network 18 may include one or more computing networks, such as other LANs, wide area networks (WAN), the Internet, and/or other remote networks, in order to transfer data between the client devices 14A-C and the network hosting the platform 20. Each of the computing networks within network 18 may contain wired and/or wireless programmable devices that operate in the electrical and/or optical domain. For example, network 18 may include wireless networks, such as cellular networks (e.g., Global System for Mobile Communications (GSM) based cellular network), WiFi® networks (WIFI is a registered trademark owned by Wi-Fi Alliance Corporation), and/or other suitable radio-based networks. The network 18 may also employ any number of network communication protocols, such as Transmission Control Protocol (TCP) and Internet Protocol (IP). Although not explicitly shown in FIG. 1, network 18 may include a variety of network devices, such as servers, routers, network switches, and/or other network hardware devices configured to transport data over the network 18.

In FIG. 1, the network hosting the platform 20 may be a remote network (e.g., a cloud network) that is able to communicate with the client devices 14A-C via the client network 12 and network 18. The network hosting the platform 20 provides additional computing resources to the client devices 14A-C and/or client network 12. For example, by utilizing the network hosting the platform 20, users of client devices 14A-C are able to build and execute applications for various enterprise, IT, and/or other organization-related functions. In one embodiment, the network hosting the platform 20 is implemented on one or more data centers 22, where each data center could correspond to a different geographic location. Each of the data centers 22 includes a plurality of virtual servers 24 (also referred to herein as application nodes, application servers, virtual server instances, application instances, or application server instances), where each virtual server 24 can be implemented on a physical computing system, such as a single electronic computing device (e.g., a single physical hardware server) or across multiple-computing devices (e.g., multiple physical hardware servers). Examples of virtual servers 24 include, but are not limited to a web server (e.g., a unitary web server installation), an application server (e.g., unitary JAVA Virtual Machine), and/or a database server, e.g., a unitary relational database management system (RDBMS) catalog.

To utilize computing resources within the platform 20, network operators may choose to configure the data centers 22 using a variety of computing infrastructures. In one embodiment, one or more of the data centers 22 are configured using a multi-tenant cloud architecture, such that one of the server instances 24 handles requests from and serves multiple customers. Data centers with multi-tenant cloud architecture commingle and store data from multiple customers, where multiple customer instances are assigned to one of the virtual servers 24. In a multi-tenant cloud architecture, the particular virtual server 24 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 24 causing outages for all customers allocated to the particular server instance.

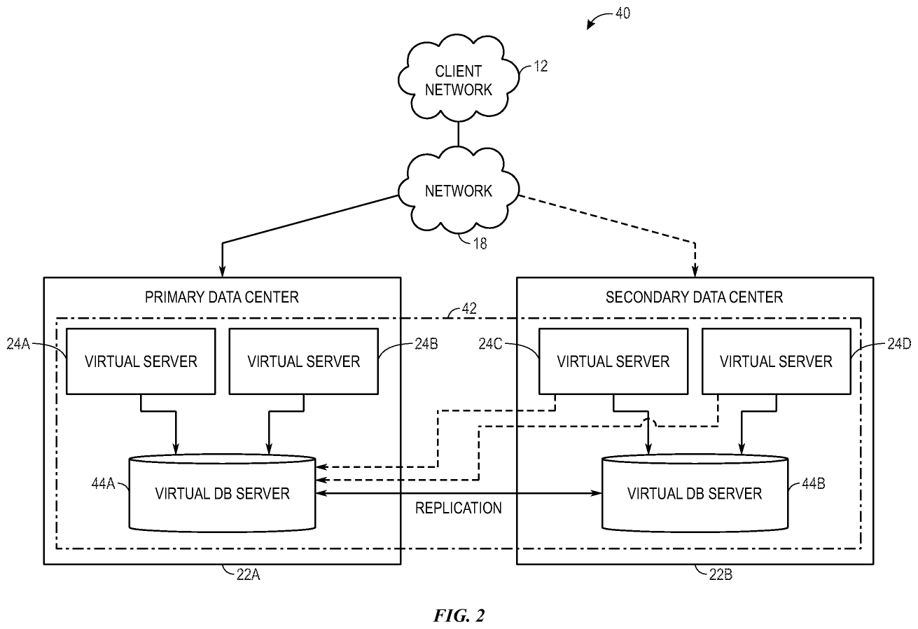

In another embodiment, one or more of the data centers 22 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 24, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 20, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a simply client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances but are specific to the respective client instance 42. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

In the depicted example, to facilitate availability of the client instance 42, the virtual servers 24A-24D and virtual database servers 44A and 44B are allocated to two different data centers 22A and 22B, where one of the data centers 22 acts as a backup data center. In reference to FIG. 2, data center 22A acts as a primary data center that includes a primary pair of virtual servers 24A and 24B and the primary virtual database server 44A associated with the client instance 42. Data center 22B acts as a secondary data center 22B to back up the primary data center 22A for the client instance 42. To back up the primary data center 22A for the client instance 42, the secondary data center 22B includes a secondary pair of virtual servers 24C and 24D and a secondary virtual database server 44B. The primary virtual database server 44A is able to replicate data to the secondary virtual database server 44B (e.g., via the network 18).

As shown in FIG. 2, the primary virtual database server 44A may replicate data to the secondary virtual database server 44B using, e.g., a Master-Master My SQL Binlog replication operation. The replication of data between data could be implemented by performing full backups weekly and daily incremental backups in both data centers 22A and 22B. Having both a primary data center 22A and secondary data center 22B allows data traffic that typically travels to the primary data center 22A for the client instance 42 to be diverted to the second data center 22B during a failure and/or maintenance scenario. Using FIG. 2 as an example, if the virtual servers 24A and 24B and/or primary virtual database server 44A fails and/or is under maintenance, data traffic for client instances 42 can be diverted to the secondary virtual servers 24C and the secondary virtual database server instance 44B for processing.

Although FIGS. 1 and 2 illustrate specific embodiments of a cloud computing system 10 and a multi-instance cloud architecture 40, respectively, the disclosure is not limited to the specific embodiments illustrated in FIGS. 1 and 2. For instance, although FIG. 1 illustrates that the platform 20 is implemented using data centers, other embodiments of the platform 20 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 24A-D and virtual database servers 44A and 44B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

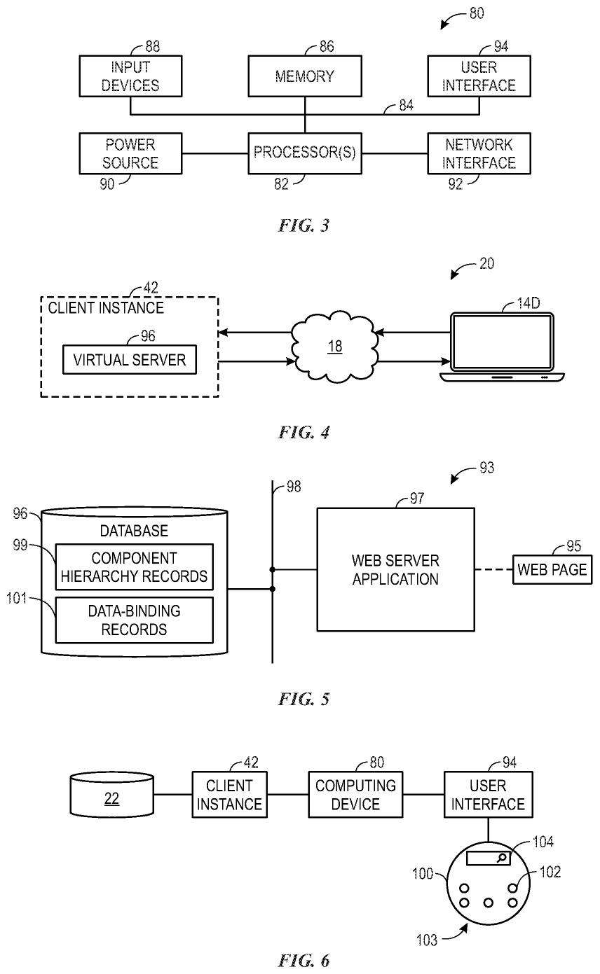

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 80 and their potential interconnections or communication paths, such as along one or more busses. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein.

The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 includes suitable electrical channels to provide data and/or power between the various components of the computing system 80. The memory 86 may include any tangible, non-transitory, and computer-readable storage media. Although shown as a single block in FIG. 1, the memory 86 can be implemented using multiple physical units of the same or different types in one or more physical locations. The input devices 88 correspond to structures to input data and/or commands to the one or more processor 82. For example, the input devices 88 may include a mouse, touchpad, touchscreen, keyboard and the like. The power source 90 can be any suitable source for power of the various components of the computing device 80, such as line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

As mentioned above, present embodiments are directed toward interactive mapping approaches for managing operations and dispatch. With the preceding in mind, FIG. 4 is a block diagram illustrating an embodiment in which a virtual server 96 supports and enables the client instance 42, according to one or more disclosed embodiments. More specifically, FIG. 4 illustrates an example of a portion of a service provider cloud infrastructure, including the cloud-based platform 20 discussed above. The cloud-based platform 20 is connected to a client device 14D via the network 18 to provide a user interface to network applications executing within the client instance 42 (e.g., via a web browser of the client device 14D). Client instance 42 is supported by virtual servers similar to those explained with respect to FIG. 2, and is illustrated here to show support for the disclosed functionality described herein within the client instance 42. Cloud provider infrastructures are generally configured to support a plurality of end-user devices, such as client device 14D, concurrently, wherein each end-user device is in communication with the single client instance 42. Also, cloud provider infrastructures may be configured to support any number of client instances, such as client instance 42, concurrently, with each of the instances in communication with one or more end-user devices. As mentioned above, an end-user may also interface with client instance 42 using an application that is executed within a web browser.

The present approach may rely on computational and communication architectures as described above to implement dynamic mapping and management techniques as discussed herein. It should also be appreciated, however, that descriptions or discussion of particular architectures and frameworks is for the purpose of illustration only and to provide useful, concrete examples of possible implementations. Indeed, with respect to the techniques discussed herein, these techniques may be implemented in a multi-instance architecture as described herein, a multi-tenant architecture, a client-server or public network (i.e., Internet) context, or, in some instances, on a single computer or server suitably configured.

With the preceding background in mind, and turning to FIG. 5 in certain embodiments, a computing system 93, such as the computing system 10, may enable a web developer to compose a web page 95 through use of custom web components and references to underlying script libraries that may be updated or changed by a provider of the computing system when desired, without necessitating rewrites of the page, as illustrated FIG. 5. Particularly, the computing system 93 may enable the web developer to compose such a web page 95 declaratively, with markup that declares desired structure and operation of the web page 95, without the need for the developer to engage in imperative coding to define how to achieve those results. Further, the web components of the computing system 93 may be structured to support inter-component data binding, and the computing system 93 may enable a web developer to declaratively bind properties of components on the web page 95 to actions emitted by other components on the web page 95. For example, as shown in FIG. 5, the computing system 93 includes a database 96, such as the cloud-based platform 20, and a web server application 97, which may be integrated or interconnected by a network, such as the network 18, or other connection mechanism 98.

As illustrated, the database 96 contains interrelated records, such as a plurality of component hierarchy records 99 cooperatively defining a hierarchical arrangement of components of the web page 95, including references to underlying scripts interpretable to define structure and operation of the components of the web page 95. The database 96 may contain further interrelated records, such as a plurality of data-binding records 101 cooperatively defining data-bindings between the components of the web page 95.

The web server application 97 executes on a computing device and is configured to carry out various web server operations (e.g., to cause the computing device to carry out the operations). For instance, the web server application 97 is configured to receive from a client device a request for the web page 95. In one implementation, the web server application 97 is configured to respond to the request by (i) querying the database 96 to ascertain a component tree-structure representing the hierarchical arrangement of the components of the web page 95 and to ascertain the data-bindings between the components of the web page 95, (ii) based on the ascertained component tree-structure and data-bindings, constructing a markup document that represents the ascertained component tree-structure and data-bindings and includes a component loader operative to load the underlying scripts, and (iii) outputting the constructed markup document for rendering by a web browser executing on the client device.

In line with the discussion above, the web server application 97 may be further configured to receive user input declaring the structure and operation of the web page 95, including declarations of the hierarchical arrangement of the components of the web page 95 and the data-bindings between the components of the web page 95. And the web server application 97 may be configured to respond to the user input by generating and storing, cooperatively in a plurality of tables of the database 96, the plurality of interrelated records cooperatively defining the hierarchical arrangement of the components of the web page 97 and the plurality of interrelated records cooperatively defining the data-bindings between the components of the web page 96, to facilitate the querying and constructing.

Further, the interrelated records (e.g., the component hierarchy records 99 and the data-binding records 101) of the database 96 may include a root-element record, a plurality of page-element records, a plurality of component records, and a plurality of data-binding records. The root-element record may define a top level of the web page. The plurality of page-element records may cooperatively define the component tree structure of the components of the web page 95, with each page-element record including a component-reference that references a respective one of the component records and including a parent-reference that references an associated parent node of the tree structure.

Each component record may define a respective component of the web page 95 and may include a script-reference that references associated underlying script that is interpretable by the web browser to define structure and operation of the component. And the data-binding records may define data-binding between (i) actions to be published by certain components of the web page 95 based on state change of the components and (ii) properties of other components of the web page 95.

With this arrangement, the act of querying the database 96 to ascertain the component tree-structure defining the hierarchical arrangement of the components of the web page 95 may involve querying the database 96 to identify the root-element record of the web page 95 and recursively querying the database 96 based on the parent-references in the page-element records, to establish the component-tree structure defining the hierarchical arrangement of the components of the web page 95.

Further, the web server application 97 may be configured to provide a user interface through which to receive the user input declaring the structure and operation of the web page 95. For instance, the user interface may define a menu of components and may enable user selection, from the menu of components, of components to be included on the web page 95 and user designation of hierarchy and data-bindings between the components. As an example, each such component, including the underlying scripts interpretable to define the structure and operation of the components, may be defined in advance of receiving the user input. With this arrangement, the underlying scripts may expose APIs of the components, and the declarations may make use of the exposed APIs. Further, the underlying scripts may be swappable while maintaining the exposed APIs. Further, it should be noted that in some embodiments, the user interface may be implemented via the webpage 95. That is, the web page 95 may receive user input declaring the structure and operation of the web page 95, as described above. In such embodiments, the web server application 97, the web page 95, and/or the user interface may be referred to as a “workspace” configured to provide the custom web components, as described herein.

The data center 22 (e.g., enterprise management data center) may provide contextual actions in the form of an interactive graphical representation of a geographic area (e.g., an interactive map) using the multi-instance cloud architecture discussed herein. For example, as illustrated in FIG. 6, an interactive map 100 (e.g., “map 100”), or graphic representation of a geographic area, may be displayed via the user interface 94 (e.g., the workspace) according to input from the client instance 42. More specifically, the interactive map 100 may be displayed via the user interface 94 supplied via a computing device 80 which may communicate with, or have access to, the client instance 42. Particularly, the map 100 may be utilized via a workspace 103, such as the web server application 97 and/or the web page 95, as described above.

As discussed herein, users may utilize the map 100 to perform a variety of functions. For example, a dispatcher (e.g., system administrator) may utilize the map 100 to interact with agents (e.g., technicians) in the field, such as to assign a task (e.g., a service task). Correspondingly, agents may utilize the map 100 to interact with the dispatcher and to receive instructions to perform the assigned task. In some embodiments, the agents may utilize the map 100 to assign or modify their own service task. Indeed, the map 100 may be customizable (e.g., configurable) to only provide certain functions (e.g., permissions, options) to certain users, which may depend on a role of the user, such as whether the user is a dispatcher or an agent.

The map 100 may include interaction elements such as icons 102 and a search field 104. The map 100, the icons 102, and the search field 104 may be generally utilized to provide contextual actions to users, as described in detail below. By way of example, the map 100 may be a visual representation of a geographic area. The icons 102 may be associated with particular objects (e.g., people, components, points of interest, etc.) within the geographic area, and accordingly, are placed in respective positions of the map 100 corresponding to the geolocations of the particular objects. As used herein, the term “geolocation” may refer to an actual geographic location in the real world. For example, a geolocation may be expressed with geographic coordinates and/or an address. Indeed, the icons 102 may be located in various positions throughout the map 100. Accordingly, a user may determine the geolocation of a first object (represented by a first icon 102) relative to the geolocation of a second object (represented by a second icon 102). The user may utilize this information to visually determine, for example, a relative distance between the first object and the second object.

A user may interact with the map 100 in various manners. As an example, each icon 102 may be associated with an object or task. Upon selection of the icon 102, the user may be provided with information associated with the icon 102. For example, a particular icon 102 may represent an agent. As such, selection of the particular icon 102 may provide a picture of the agent, a skill level of the agent, a status (e.g., in transit, on break, at a task, available, etc.) of the agent, shift hours of the agent, parts accessible to the agent, and so forth. As a further example, a certain icon 102 may represent a building (e.g., a warehouse or store). As such, selection of the certain icon 102 may provide a picture of the warehouse, hours of operation of the warehouse, components carried by the warehouse, and so forth. In some embodiments, information associated with the icon 102 may be provided without first selecting the icon 102. Indeed, it should be understood that the information associated with the icon 102 may be configurable and provided according to user preference or characteristics. That is, some information may be permanently displayed with the icon 102 while some information may be provided upon selection, according to user preference or characteristics. In some embodiments, certain information associated with an icon 102 may be configured to appear when a cursor, for example, is placed to hover above the icon 102.

Further, users may utilize the search field 104 to search for certain objects (e.g., parts, tasks, people, etc.) of the map 100. For example, a user may enter a search string (e.g., indicative of one or more objects) and the map 100 may return (e.g., display) icons 102 or other elements related to the search string. In some embodiments, if the entered search string is related to one or more objects displayed on the map 100, the one or more icons 102 related to the one or more objects may be accentuated (e.g., appear, enlarged, highlighted, brought to front, etc.).

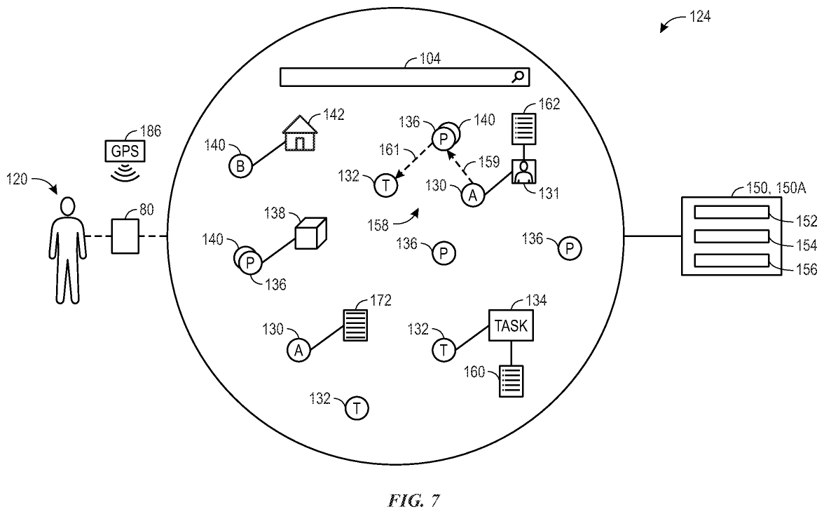

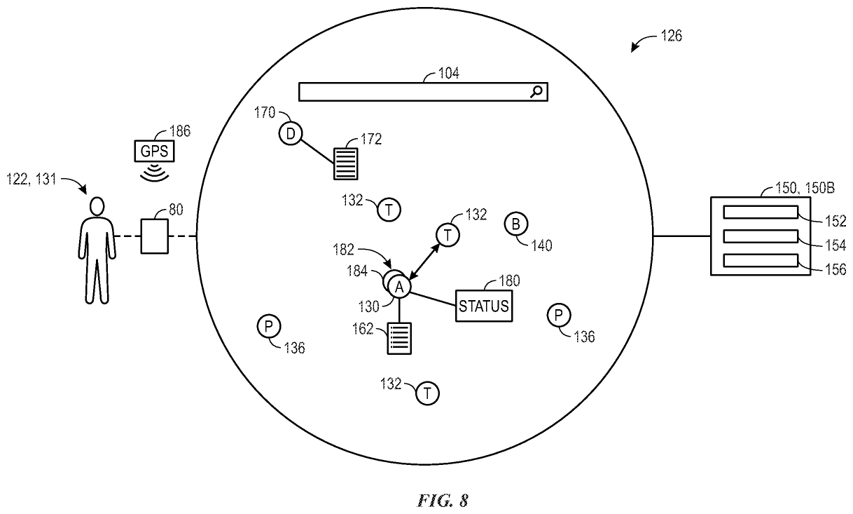

As discussed herein, the map 100 may be configured to allow different permissions (e.g., functions) depending on the user accessing the map 100, such as via the workspace 103. For example, FIG. 7 shows an embodiment of the map 100 that may be accessible by a user with a high clearance, or with more permission, such as a dispatcher 120, or a system administrator. Correspondingly, FIG. 8 shows an embodiment of the map 100 that may be accessible by a user with low clearance, or with less permission, such as an agent 122, or a technician. Both the dispatcher 120 and the agent 122 may interact with their respective map 100 via a respective computing device 80, which may include an input device, such as a mouse or touch screen, by which the user may interact with the map 100 or other interface elements related to use or display of the map 100. In some embodiments, the input device computing device 80 may be actuated with voice commands. Additionally, as discussed herein, the map 100 of FIG. 7 may specifically be referred to as a dispatcher map 124 and the map 100 of FIG. 8 may specifically be referred to as an agent map 126. Further, it should be noted that both of the dispatcher map 124 and the agent map 126 may collectively be referred to as the map 100, or maps 100. In the following discussion, the FIG. 7 and FIG. 8 will be discussed in parallel.

As illustrated in the current embodiments, the maps 100 of FIGS. 7 and 8 may display icons 102 including agent icons 130 corresponding to geolocations of agents 131, task icons 132 corresponding to geolocations of tasks 134 (e.g., service tasks), part icons 136 corresponding to geolocations of parts 138, and buildings of interest (e.g., “buildings”) icons 140 corresponding to geolocations of buildings 142, such as stores, warehouses, or restrooms. Further, it should be noted that, while every icon 102 may be associated with a respective object (e.g., agents 131, tasks 134, parts 138, and buildings 142), only a portion of the icons 102 are illustrated with respective objects at least in part to provide clarity and accentuate certain features in the discussion herein.

As discussed herein, the dispatcher map 124 and the agent map 126 may be associated with different permission levels (e.g., functions), and as such, may display differing information. For example, the dispatcher map 124 may display agent icons 130 associated with a plurality of agents while the agent map 126 may only display an agent icon 130 associated with the agent 122 utilizing the agent map 126. More specifically, the agent icon 130 associated with the agent 122 may indicate a geolocation of the agent 122. Similarly, in certain embodiments, the dispatcher map 124 may display a plurality of task icons 132 while the agent map 126 may only display tasks 134 that have been assigned to the agent 122. However, it should be understood that the types of icons 102 and information displayed on the dispatcher map 124 and the agent map 126 may be configurable (e.g., adjustable) based on user (e.g., system administrator) preference, which may be configured via the workspace 103, as described above. Indeed, in certain embodiments, the agent map 126 map provide multiple task icons 132 and/or other agent icons 130.

The maps 100 may be associated with functions 150 such as task functions 152, communication functions 154, and search functions 156. Specifically, the dispatcher map 124 may be associated with a first set of functions 150a and the agent map 126 may be associated with a second set of functions 150b that is different than the first set of functions 150a.

For example, as discussed in further detail below, task functions 152 of the dispatcher map 124 may include assigning tasks 134 to agents 131 while the task functions 152 of the agent map 126 may include accepting or declining the task 134 that the dispatcher 120 has assigned to the agent 122. Moreover, in certain embodiments, the maps 100 may provide suggested routes to efficiently complete the tasks 134 considering the respective geolocations of the tasks 134 and the agents 130. In other words, the maps may provide “best fit” routes to complete the tasks 134.

To illustrate, with regard to the dispatcher map 124, the task functions 152 may include assignment of a task 132. To assign a particular task 134 to a certain agent 131, in some embodiments, a dispatcher 120 may drag and drop (e.g., utilizing the computing device 80) a task icon 132 associated with the particular task 134 to an agent icon 130 associated with the certain agent 131. Similarly, in some embodiments, the dispatcher 120 may drag and drop the agent icon 130 associated with the certain agent 131 to the task icon 132 associated with the particular task 134 to assign the certain agent 131 to the particular task 134. In other words, dragging and dropping the task icon 132 to the agent icon 130 or dragging and dropping the agent icon 130 to the task icon 132 may each provide the same function, such as associating the task 132 with an agent 131 or assigning the task 134 to the agent 131.

Correspondingly, with regard to the agent map 126, when a task 134 is assigned to the agent 122, the agent map 126 may display a notification related to the assigned task 134. For example, the agent 122 may utilize the agent map 126 to accept or decline the assigned task 134. That is, the task functions 152 of the agent map 126 may include accepting or declining the task 134 that may have been assigned using the task functions 152 of the dispatcher map 124. In other embodiments, the agent map 104 may simply notify the agent 122 using the agent map 126 that the task 134 has been assigned to him/her and the agent 122 may not be provided with an option to accept or decline the task 134. Still further, in certain embodiments, the agent map 126 may provide task functions 152 that enable the agent 122 to draft (e.g., assign) a task 134 to him or herself. For example, the agent 122 may drag and drop a task icon 132 to the agent icon 130 associated with the agent 122 to assign the task associated with the task icon 132 to him or herself.

Once a task 134 has been assigned to an agent 131, the agent map 126 may provide instructions to perform the task 134. That is, the instructions to perform the task 134 may include a travel route to the geolocation of the task 134, details (e.g., a work order) associated with the task 134, parts 138 that may be needed to complete the task 134 (and where they may be located), and so forth. In some embodiments, the travel route to the geolocation of the task 134 may include one or more stops associated with geolocations of parts 138 that may be needed to complete the task 134.

In some embodiments, when the map 100 is used to select a task 134 or assign a task 134, the map 100 may be populated by (e.g., display) one or more icons 102 related to the task 134. For example, the map 100 may be populated by part icons 136 indicative of parts 138 required to complete the task 134. To illustrate, the task 134 may be associated with a task parts list 160 indicating the parts 138 required to complete the task 134. An agent 131 may similarly be associated with an agent parts list 162 indicating parts 138 that are accessible to the agent 131. As used herein, the parts 138 that are referred to as accessible to an agent 131, or that an agent 131 has access to, may refer to parts 138 that the agent 131 has on hand, such as within their work vehicle or on their person. In other words, accessible parts 138 may refer to parts 138 that are readily accessible to a particular agent 131. When the task 134 is assigned to (or associated with) the agent 131, discrepancies between the agent parts list 162 and the task parts list 160 may be determined. More specifically, the parts 138 that are needed to complete the task 132 and that are not accessible to the agent 131 may be determined.

The dispatcher map 124 and/or the agent map 126 may then be populated by one or more part icons 136 indicative of the parts 138 that are needed to complete the assigned task 134 and that are not accessible to the agent 131. In this manner, the dispatcher 120 may determine a route 158 for the agent 131 to travel to pick up the necessary parts 138 for the assigned task 134 before arriving at the geolocation associated with the task 134.

In certain embodiments, the parts 138 may be associated with building icons 114. That is, a warehouse or store may carry, or have, the parts 138. Accordingly, if a part 138 that is required to complete a task 134 is held by a warehouse associated with the building icon 140, the dispatcher 120 and/or the agent 122 may select the building icon 140 to reserve the parts 138 needed for the task 134, reserve a pick up time, and so forth. In some embodiments, a particular part 138 that is needed for a task 134 may be accessible to a second agent 131 that is relatively close to the agent 131 assigned to the task 134. Accordingly, in such embodiments, the dispatcher 120 may contact the second agent 131 to notify the second agent 131 that the agent 131 assigned to the task 134 is in transit to pick up the part 138.

In some embodiments, to assign the route 158 of picking up the necessary parts 138 and arriving at the geolocation associated with the task 134, the dispatcher 120 may drag and drop the agent icon 130 to the part icons 136 associated with the parts 138 that are to be picked up, and then drag and drop the agent icon 130 to the task icon 132. Particularly, in certain embodiments, to assign a task 134 that requires a part 138 to be picked up, the dispatcher 120 may drag and drop the agent icon 130 to the part icon 136, and then drag and drop the agent icon 130 from the part icon 136 to the task icon 132. In other embodiments, to assign a task 134 that requires a part 138 to be picked up, the dispatcher 120 may drag and drop the agent icon 130 from a portion of the dispatcher map 124 associated with the geolocation of the agent 131 to the part icon 136, which may establish a first portion 159 of the route 158, and then drag and drop the agent icon 130 from the portion of the dispatcher map 124 associated with the geolocation of the agent 131 to the task icon 132, which may establish a second portion 161 of the route 158.

Further, in certain embodiments, once the route 158 has been determined, such as through dragging and dropping the associated icons 102, as described above, the route 158 may be displayed via the dispatcher map 124, as shown, and the dispatcher 120 may further be provided with options to accept the route and send the route 158 to the agent 131 and/or to augment the route 158 before sending the route 158 (e.g., schedule) to the agent 131. Moreover, as discussed above, the agent 131 assigned to the task 134 may be required to pick up additional parts 138 required for the task 134. Accordingly, depending on whether the agent 131 has access to all of the necessary parts 138 for the assigned task 134, the agent 131 may receive directions to pick up the necessary parts 138 when assigned to the task 134, or may receive directions directly to the geolocation of the task 134 if the agent 131 has access to all of the necessary parts 138 for the task 134. For example, a task 134 may include a network installation, which may require a router. Accordingly, if the agent 131 does not have access to the router, the agent 131 may first be routed to a nearby warehouse, store, or agent 131 to pick up the router before travelling to the geolocation associated with the task 134.

Further, the maps 100 may include the communication functions 154. The communication functions 154 may provide a manner in which the dispatcher 120 and the agents 131 may communicate. For example, in certain embodiments, the dispatcher 120 may utilize the dispatcher map 124 to communicate with any of the agents 131 displayed via the agent icons 130 on the dispatcher map 124. Similarly, in certain embodiments, the agent 122 may utilize the agent map 126 to communicate with the dispatcher 120 and/or other agents 131. Particularly, in certain embodiments, the dispatcher 120 may be associated with a dispatcher icon 170 associated with the dispatcher 120. In certain embodiments, the dispatcher icon 170 may be positioned in the agent map 126 such that the dispatcher icon 170 corresponds to the geolocation of the dispatcher 120, such as the geolocation of an office, or headquarters. In other embodiments, the dispatcher icon 170 may be positioned in a location of the agent map 126 that may not be associated with the geolocation of the dispatcher 120. In some embodiments, if the agent map 126 is configured as such, the agent 122 may communicate with other agents 131 through the agent map 126.

In certain embodiments, communication functions 154, as provided via the maps 100, may be in the form of chat boxes 172, which are configured to receive input from the agent 122 or the dispatcher 120 via the computing device 80, which may include a keyboard. That is, the dispatcher 120 may type a message into a chat box 172 associated with a particular agent icon 130, as shown in FIG. 7. Similarly, the agent 122 may type a message into a chat box 172 associated with the dispatcher icon 170, as shown in FIG. 8.

In some embodiments, the communication functions 154 of the map 100 may include verbal communication. For example, the agent map 126 and/or the dispatcher map 124 may be linked to a phone application of the computing device 80, which may be a portable computing device, such as a laptop or smart phone. Accordingly, the dispatcher map 124 may provide the dispatcher 120 with an option to call the agent 122 upon selection of an agent icon 130 associated with the agent 122. In certain embodiments, the dispatcher map 124 may provide the dispatcher 120 with a phone number associated with the selected agent icon 130. Similarly, the agent map 126 may provide the agent 122 with an option to call the dispatcher 120 upon selection of the dispatcher icon 170. In certain embodiments, the agent map 126 may provide the agent 122 with a phone number associated with the selected dispatcher icon 170. As discussed herein, the agent map 126 may be configured to provide communication functions 154 to enable communication between the agent 122 and other agents 131, between the agent 122 and the dispatcher 120, between the agent 122 and certain buildings 142, and so forth, depending at least on user preferences of the agent map 126, such as permissions set by a system administrator via the workspace. Similarly, the dispatcher map 124 may be configured to provide communication functions 154 to enable communication between the dispatcher 120 and agents 131, between the dispatcher 120 and other dispatchers 120, between the dispatcher 120 and certain buildings 142, and so forth.

Further, each of the dispatcher map 124 and the agent map 126 may be associated with respective searching functions 156. Generally, the maps 100 may include the search field 104 that a user (e.g., the agent 122 or the dispatcher 120) may utilize to search a respective map 100 for various objects (e.g., agents 131, tasks 134, parts 138, and buildings 142). For example, a particular task 134 may require certain parts 138. Accordingly, a user may utilize the search field 104 to search for the certain parts 138. As discussed herein, the searching functions 156 of the maps 100 may vary from the dispatcher map 124 to the agent map 126, depending on a user preference. For example, in certain embodiments search results provided by the agent map 126 may be limited to search results (e.g., objects) associated with tasks 134 that have been assigned to the agent 122, such as parts 138 required for the assigned task 134.

Furthermore, in certain embodiments, the agent map 126 may provide the agent 122 with options to update a status 180 of the agent 122. For example, upon initiating travel to a geolocation associated with a task 134, part 138, building 140, the agent may update the status 180 to “in transit”, or “busy”. As a further example, while the agent 122 is at a geolocation of a building 142, the agent 122 may update the status 180 to indicate that the agent 122 has picked up a part 138 from the building 142. More particularly, the agent 122 may update the agent parts list 162.

The map 100 may update locations of the icons 102 based on one or more inputs. For example, in certain embodiments, the agent 122 may update a current location 182 of the agent 122, which may be represented by a location icon 184, by submitting for example, coordinates or an address. In some embodiments, the computing device 80 may be associated with a global positioning system (GPS) 186. In such embodiments, the GPS 186 may communicate one or more signals indicative of the geolocation of the computing device 80 to the client instance 42 to update the location icon 184. In certain embodiments, when the location icon 184 of the agent map 126, and more specifically, the current location 182, is updated, a corresponding agent icon 130 associated with the agent 122 of the current location 182 may similarly be updated on the dispatcher map 124.

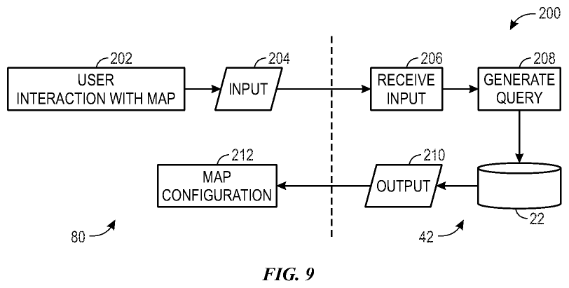

As discussed herein, actions taken by the dispatcher 120 via the dispatcher map 124 may cause one or more changes to occur to the agent map 126. Similarly, actions taken by the agent 122 via the agent map 126 may cause one or more changes to occur to the dispatcher map 124. To illustrate, FIG. 9 is a flow chart of an embodiment of a process 200 that may be utilized to configure (e.g., adjust permissions, functions 150, icons 102, and so forth) the map 100 via the client instance 42. For example, to initiate the process 200, the computing device 80 may receive input through one or more interaction points (e.g., the icons 102 displayed via the map 100) (block 202). Particularly, as discussed herein, the input via the interaction points may include dragging and dropping a first icon to a second icon to assign a task or determine a route, for example. Upon receiving input via the interaction points (block 202), data 204 indicative of the input associated with the interaction points may be generated and sent to the client instance 42. The client instance 42 may receive the feedback (block 206) and generate a query (block 208) according to the received data 204.

Particularly, queries may be generated using GraphQL. GraphQL is a publicly released query language available since 2015. See, e.g., https://graphql.org/. Compared to other query languages, GraphQL is hierarchical and generally enables queries to have greater specificity, which can substantially reduce overhead involving querying and transferring superfluous or undesired data. Additionally, GraphQL is a strongly typed query language, which enables developers to clearly define the data types for fields of a query.

In general, the query may utilize SQL, representational state transfer (REST), and/or GraphQL. The query may be sent to the data-center 22. Particularly, the data-center 22 may register the query and provide an output (e.g., response) 210 associated with the query, which is sent to the one or more computing devices 80. Upon receiving the output 210, the one or more computing devices 80 may configure the map (block 212) according to the data indicative of the output 210, such as by implementing one or more changes to the interaction points or providing instructions to complete a task. For example, if the initial user interaction with the map (block 202) includes a dispatcher dragging and dropping a first icon to a second icon to assign a task to an agent, a computing device 80 associated with the agent may receive the output 210 and notify the agent that the task has been assigned to him/her. In some embodiments, the changes to the interaction points (block 212) may include instructions to perform an assigned task, such as directions to the geolocation associated with the task or details (e.g., a work request) associated with the task.

Further, it should be noted that while several processes described herein may utilize dragging and dropping certain icons 102, the same processes may be utilized with other suitable methods, such as selecting an icon 102 and then selecting where the icon 102 may have been dragged.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
an enterprise management data-center remotely located from one or more client networks;
a client instance hosted by the enterprise management data-center for the one or more client networks, wherein instructions executed by the enterprise management data-center causes the system to perform operations comprising:
configuring interaction points for a workspace of the client instance, wherein the interaction points are disposed on a geographic map displayed in the workspace;
receiving, via the interaction points of the workspace, data indicative of a service task comprising a plurality of locations associated with the geographic map displayed in the workspace, wherein the data indicates dragging and dropping an icon from a first location of the plurality of locations to a second location of the plurality of locations; and
providing, via the interaction points of the workspace, instructions to perform one or more parts of the service task based on the data that indicates dragging and dropping.

2. The system of claim 1, wherein the interactions points comprise an agent icon positioned on the geographic map according to a first geolocation of an agent, wherein the interaction points comprise a task icon positioned on the geographic map according to a second geolocation of the service task, and wherein dragging and dropping the icon comprises dragging and dropping the agent icon to the task icon to assign the service task to the agent.

3. The system of claim 2, wherein the dragging and dropping the icon to assign the service ask to the agent further comprises dragging and dropping the agent icon to a part icon associated with a third geolocation of a part, and wherein providing the instructions to perform one or more parts of the service task comprises providing a route from the first geolocation of the agent to the second geolocation of the part to the third geolocation of the service task.

4. The system of claim 1, wherein the geographic map comprises a first geographic map displayed via a first user interface of a first computing device, and wherein the graphic representation comprises a second geographic map displayed via a second user interface of a second computing device.

5. The system of claim 4, wherein the data indicative of the service task is configured to be received via interaction points disposed on the first graphic representation, and wherein the instructions to perform one or more parts of the service task is configured to be displayed via the second graphic representation.

6. The system of claim 4, wherein the first geographic map is associated with a first set of functions, wherein the second geographic map is associated with a second set of functions, and wherein the first set of functions is different from the second set of functions.

7. The system of claim 6, wherein the first geographic map comprises a first agent icon associated with a first geolocation of a first agent and a second agent icon associated with a second geolocation of a second agent, and wherein the first set of functions comprises assigning a first task to the first agent by dragging and dropping a first task icon to the first agent icon, and assigning a second task to the second agent by dragging and dropping a second task icon to the second agent icon.

8. The system of claim 7, wherein the second set of functions comprises receiving, via the second geographic map, instructions to perform one or more parts of the first task.

9. A method, comprising:
providing, via one or more user interfaces, a plurality of interactive icons disposed on one or more geographic maps;
receiving data indicative of dragging and dropping a first icon of the plurality of icons to a second icon of the plurality of icons; and
assigning, via the one or more user interfaces, instructions to perform a service task based on the dragging and dropping.

10. The method of claim 9, comprising:
receiving, via a first user interface of the one or more user interfaces, the data indicative of dragging and dropping the first icon of the plurality of interactive icons to the second icon of the plurality of interactive icons; and
assigning, via a second user interface of the one or more user interfaces, the service task based on the dragging and dropping.

11. The method of claim 10, wherein the first icon comprises a task icon and the second icon comprises an agent icon, and wherein assigning the service task comprises assigning the service task via an agent user interface of the one or more user interfaces.

12. The method of claim 9, comprising:
providing, via the one or more user interfaces, a search field;
receiving, via the search field, data indicative of a search string;
providing, via the geographic map, one or more icons of the plurality of interactive icons associated with the search string.

13. The method of claim 9, comprising:
providing a first geographic map of the one or more geographic maps, wherein the first geographic map is associated with a first set of functions; and
providing a second geographic map of the one or more user geographic maps, wherein the second user interface is associated with a second set of functions, and wherein the first set of functions is different from the second set of functions.

14. The method of claim 13, comprising:
providing, via the one or more geographic maps, communication functions configured to enable communication between a first geographic map of the one or more geographic maps and a second geographic map of the one or more geographic maps.

15. A non-transitory, computer readable medium comprising instructions, wherein the instructions are configured to be executed by a processor to perform operations comprising:
providing, via one or more user interfaces, a plurality of icons disposed on one or more geographic maps;
receiving data indicative of dragging and dropping a first icon of the plurality of icons to a second icon of the plurality of icons; and
assigning, via the one or more user interfaces, instructions to perform a service task based on the dragging and dropping.

16. The non-transitory, computer readable medium of claim 15, wherein the operations comprise:
receiving, via a first user interface of the one or more user interfaces, the data indicative of dragging and dropping the first icon of the plurality of icons to the second icon of the plurality of icons; and
assigning, via a second user interface of the one or more user interfaces, the service task based on the dragging and dropping.

17. The non-transitory, computer readable medium of claim 16, wherein the first icon comprises a task icon and the second icon comprises an agent icon, and wherein assigning the service task comprises assigning the service task via an agent user interface of the one or more user interfaces.

18. The non-transitory, computer readable medium of claim 15, wherein the operations comprise:
providing, via the one or more user interfaces, a search field;
receiving, via the search field, data indicative of a search string;
providing, via the geographic map, one or more icons of the plurality of icons associated with the search string.

19. The non-transitory, computer readable medium of claim 15, wherein the operations comprise:
providing a first geographic map of the one or more geographic maps, wherein the first geographic map is associated with a first set of functions; and
providing a second geographic map of the one or more user geographic maps, wherein the second user interface is associated with a second set of functions, and wherein the first set of functions is different from the second set of functions.

20. The non-transitory, computer readable medium of claim 15, wherein the operations comprise:
providing, via the one or more geographic maps, communication functions configured to enable communication between a first geographic map of the one or more geographic maps and a second geographic map of the one or more geographic maps.
